(19) United States
(12) Patent Application Publication
(10) Pub. No.: US 2026/0066596 A1
(43) Pub. Date: Mar. 5, 2026

(54) RF CONNECTOR AND CONNECTOR ASSEMBLY

(71) Applicant: OUPIIN Electronic (Kunshan) Co., Ltd, Kunshan City (CN)

(72) Inventor: Hsin Chih CHEN, Kunshan City (CN)

(73) Assignee: OUPIIN Electronic (Kunshan) Co., Ltd, Kunshan City (CN)

(21) Appl. No.: 19/013,037

(22) Filed: Jan. 8, 2025

(30) Foreign Application Priority Data
Aug. 27, 2024 (CN) 202411182032.8
Aug. 27, 2024 (CN) 202422082929.5

(51) Int. Cl. H01R 24/40

(52) U.S. Cl. CPC H01R 24/40; H01R 2201/26

(57) ABSTRACT

An RF connector and a connector assembly are disclosed in this application. The RF connector includes an insulation base and at least one central conductor component. The central conductor component includes an inner conductor, an insulation support member, an inner shielding ring and an outer conductor. The inner shielding ring is disposed on an outer peripheral surface of the insulation support member. The outer conductor surrounds the insulation support member, and forms a circular insertion space between the outer conductor and the inner shielding ring for an outer shielding shell of a mating conductor component of a mating connector to be inserted into it. The RF connector and the connector assembly of the present application are particularly suitable for transmitting high-frequency signals, and can achieve a transmission frequency of 20 GHz.

### CROSS REFERENCE TO RELATED APPLICATIONS

This application is a Paris Convention, which claims the benefit of priority of Chinese Patent Application No. 202411182032.8 filed on Aug. 27, 2024 and Chinese Patent Application No. 202422082929.5 filed on Aug. 27, 2024. The contents of the above applications are all incorporated by reference as if fully set forth herein in their entirety.

### FIELD AND BACKGROUND OF THE INVENTION

The present application relates to a field of radio frequency connector, and more specifically to an RF connector and a connector assembly being suitable for transmitting high-frequency signals.

With the continuous advancement of automotive technology, a FAKRA RF connector has been applied to a GPS system, a satellite radio, vehicle Internet access, engine management and other modules. However, whether it is a vehicle mounted radar system, a wireless communication module, or an advanced audio and video device, the RF connector is required to provide stable and efficient signal transmission to ensure the operation of various functions.

The existing RF connectors can achieve operating frequencies of 4 GHz, 6 GHz, and even 9 GHz. For example, a US Patent document with publication number US20200119495A1 discloses a contact element for a connector. The contact element (1) includes a housing (3) being substantially tubular and made of metal, a contact sleeve (12) and an electrically insulating support (8). There are two groups of resilient tongues (10, 11) disposed on the contact sleeve for improving the electrical connection between outer conductors of two engaged connectors. The connector with the contact element of US20200119495A1 can achieve a transmission frequency of at least 9 GHz.

However, it has been found that the existing RF connectors experience a significant attenuation of signals and a noticeable decrease in communication quality when reaching higher frequencies. Therefore, it is necessary to research a connector that can break through the existing operating frequency.

### SUMMARY OF THE INVENTION

One object of the present application is to provide an RF connector that can effectively control impedance and reduce attenuation and reflection of signals to achieve better communication quality when transmitting higher frequency signals.

Another object of the present application is to provide a connector assembly that can transmit higher frequency signals and achieve better communication quality during connections.

Other objects and advantages of the present application may be further understood from technical features disclosed by the present application.

To achieve the above objects of the present application, the present application adopts the following technical solution.

An RF connector comprises an insulation base and at least one central conductor component disposed in the insulation base. The central conductor component includes an inner conductor, an insulation support member, an inner shielding ring and an outer conductor. The inner conductor has a contact portion and a connection portion, wherein the contact portion is used to be engaged with a mating conductor component of a mating connector. The insulation support member has a central cavity for accommodating and supporting the inner conductor, the insulation support member includes a front support section and a rear support section, the contact portion of the inner conductor extends into the front support section, and the connection portion of the inner conductor extends into the rear support section. The inner shielding ring is disposed on an outer peripheral surface of the insulation support member and located on the front support section. The outer conductor surrounds the insulation support member and the inner shielding ring, and defines an annular insertion space between the outer conductor and the inner shielding ring for inserting an outer shielding shell of the mating conductor component of the mating connector therein.

In one embodiment, the inner shielding ring is an independent member, which is embedded in the insulation support member by an installation method or an integral molding process and is exposed to the annular insertion space.

In one embodiment, the inner shielding ring is a metal layer or a metal surface formed on the outer peripheral surface of the insulation support member.

In one embodiment, the inner shielding ring is provided with a locking portion; the insulation support member is provided with an engaging portion on the outer peripheral surface; the locking portion is engaged with the engaging portion for fixing the inner shielding ring on the outer peripheral surface of the insulation support member; and the locking portion of the inner shielding ring is a sheet that is bent toward an inner side of the inner shielding ring, the engaging portion of the insulation support member is a groove, and the sheet is held in the groove.

In one embodiment, the inner conductor is a hollow tube, and the contact portion of the inner conductor is shaped like a claw; the connection portion of the inner conductor is connected to a central wire of a cable, and is fixed through a conductive sleeve; the conductive sleeve is pressed onto a shielding layer of the cable; and the inner conductor is provided with protrusions that can be pressed against an inner wall of the central cavity.

In one embodiment, the outer conductor has a front conductive portion and a rear conductive portion; the front conductive portion surrounds the front support section and the inner shielding ring, and the annular insertion space is defined between the front conductive portion and the inner shielding ring; and the rear conductive portion surrounds and is pressed onto the conductive sleeve.

In one embodiment, the outer conductor further has a middle conductive portion; an inner diameter of the middle conductive portion is smaller than an inner diameter of the front conductive portion and also smaller than an inner diameter of the rear conductive portion; and the middle conductive portion surrounds and is fixed on the insulation support member.

In one embodiment, the front conductive portion is shaped like a claw, and has at least one elastic arm; and at least a part of the elastic arm protrudes toward the annular insertion space.

To achieve the above objects of the present application, the present application also adopts the following technical solution.

A connector assembly comprises an RF connector and a mating connector. The RF connector includes an insulation base and at least one central conductor component disposed in the insulation base. The central conductor component includes an inner conductor, an insulation support member, an inner shielding ring and an outer conductor. The inner conductor has a contact portion and a connection portion. The insulation support member includes a front support section and a rear support section, the contact portion of the inner conductor is located in the front support section, and the connection portion of the inner conductor is located in the rear support section. The inner shielding ring is disposed on an outer peripheral surface of the insulation support member and located on the front support section. The outer conductor surrounds the insulation support member, and defines a circular insertion space between the outer conductor and the inner shielding ring. The mating connector includes a mating base and at least one mating conductor component disposed in the mating base. The mating conductor component includes a central pin, an insulation housing for fixing the central pin, and an outer shielding shell surrounding the insulation housing. The central pin has an insertion end and a retaining end; wherein the insertion end extends out of the insulation housing. The outer shielding shell forms a mating space, and the insertion end of the central pin is located in the mating space. Wherein, when the RF connector and the mating connector are engaged, the central pin contacts with the contact portion of the inner conductor for transmitting signals, the outer shielding shell is inserted into the circular insertion space, and the front support section and the inner shielding ring enter into the mating space of the out shielding shell; wherein, the outer conductor contacts with the outer shielding shell, and the outer shielding shell contacts with the inner shielding ring.

In one embodiment, the insulation base includes at least one passage for retaining the central conductor component; the insulation base includes a latch structure disposed on a top of the insulation base; the mating base forms a cavity, and the mating conductor component is fixed in the the mating base and extends into the cavity; and the mating base includes a retaining structure disposed on a top of the mating base; when the mating connector is engaged with the RF connector, the insulation base enters into the cavity of the mating base, and the retaining structure is mated with the latch structure.

In comparison with the prior art, the RF connector and the connector assembly of the present application are provided with the inner shielding ring on the insulation support member, thereby controlling the impedance of the RF connector and reducing attenuation and reflection of signals to achieve better communication quality when transmitting higher frequency signals. The RF connector and the connector assembly of the present application are particularly suitable for transmitting high-frequency signals, and can achieve a transmission frequency of 20 GHz.

### BRIEF DESCRIPTION OF DRAWINGS

FIG. 1 is a perspective schematic view of an RF connector of the present application;

FIG. 2 is an exploded view of the RF connector of the present application;

FIG. 3 is a perspective schematic view of one central conductor component of the RF connector of the present application;

FIG. 4 is a cross-sectional view of the central conductor component of FIG. 3;

FIG. 5 is an exploded view of the central conductor component of FIG. 3, mainly demonstrating a structural relationship between an inner shielding ring and an insulation support member by removing an outer conductor;

FIG. 6 is a complete exploded view of the central conductor component of FIG. 5;

FIG. 7 is a perspective schematic view of a mating connector mated with the RF connector of the present application;

FIG. 8 is an exploded view of the mating connector of FIG. 7;

FIG. 9 is a perspective schematic view of one mating conductor component of the mating connector of FIG. 8;

FIG. 10 is a cross-sectional view of the mating conductor component of FIG. 9;

FIG. 11 is an exploded view of the mating conductor component of FIG. 9;

FIG. 12 is a perspective schematic view of the connector assembly of the present application in a mating state, including the RF connector of the present application and the mating connector of FIG. 7;

FIG. 13 is a combination schematic view of the central conductor component and the mating conductor component; and

FIG. 14 is a cross-sectional view of the central conductor component and the mating conductor component at a combination location.

### DESCRIPTION OF SPECIFIC EMBODIMENTS OF THE INVENTION

The following description of every embodiment with reference to the accompanying drawings is used to exemplify a specific embodiment, which may be carried out in the present application. Directional terms mentioned in the present application, such as “top”, “bottom”, “front”, “back”, “left”, “right”, “top”, “bottom” etc., are only used with reference to the orientation of the accompanying drawings. Therefore, the used directional terms are intended to illustrate, but not to limit, the present application.

An RF (Radio Frequency) connector of the present application can solve the problem of impedance discontinuity caused by significantly high impedance in existing structures, which further leads to attenuation and increased reflection of signals when transmitting higher frequency signals. The RF connector of the present application is particularly suitable for transmitting high-frequency signals, and can achieve a transmission frequency of 20 GHz.

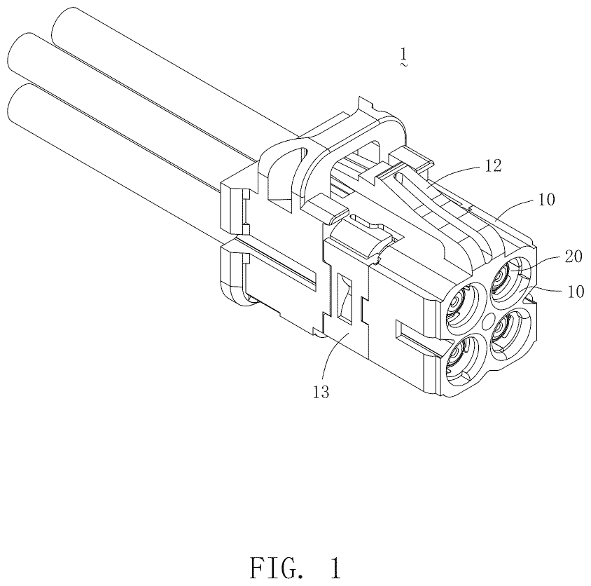

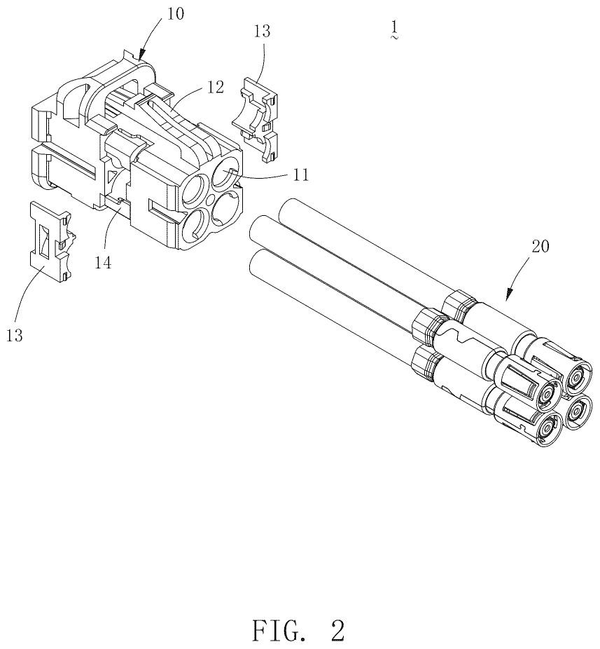

Please refer to FIGS. 1 and 2, the RF connector 1 of the present application includes an insulation base 10 and at least one central conductor component 20 disposed in the insulation base 10.

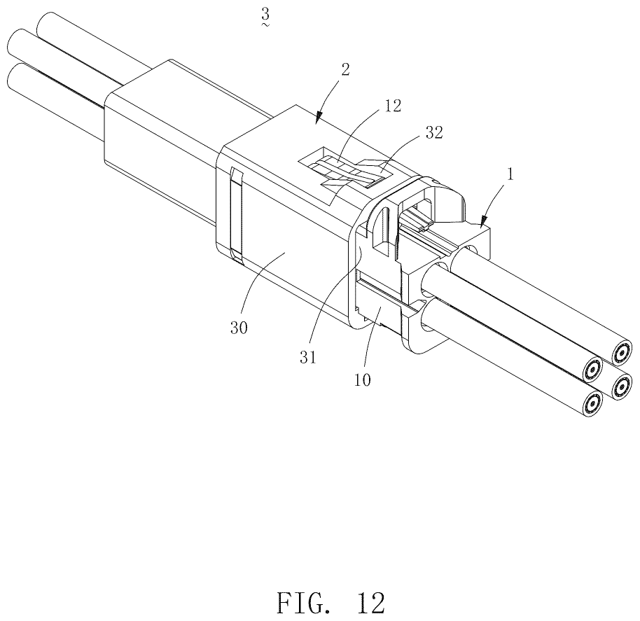

The insulation base 10 includes at least one passage 11 for retaining the central conductor component 20. The insulation base 10 further includes a latch structure 12 disposed on a top of the insulation base 10. As shown in FIG. 12, when the RF connector 1 is engaged with the mating connector 2, the latch structure 12 locks the mating connector 2.

In the embodiment, the RF connector 1 further includes a pair of fixing members 13 mounted recesses 14 on two sides of the insulation base 10 to restrict the movement of the central conductor component 20.

In the embodiment, the RF connector 1 of the present application includes four central conductor components 20. The present application does not limit the number of the central conductor components 20.

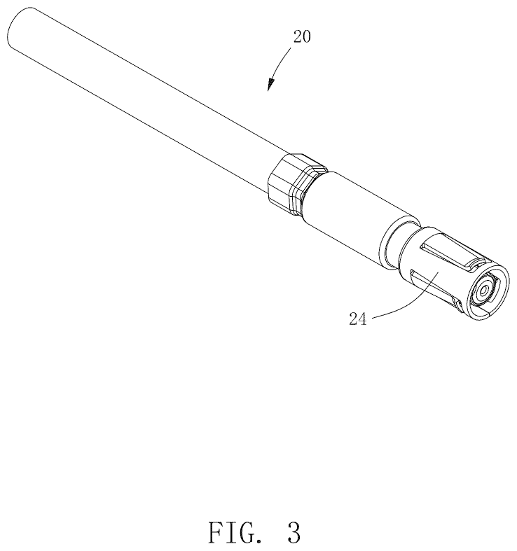

The central conductor component 20 is disposed in the passage 11 of the insulation base 10. Please refer to FIGS. 3 to 6, the central conductor component 20 includes an inner conductor 21, an insulation support member 22 for supporting the inner conductor 21, an inner shielding ring 23 disposed on an outer peripheral surface of the insulation support member 22, and an outer conductor 24 surrounding the insulation support member 22.

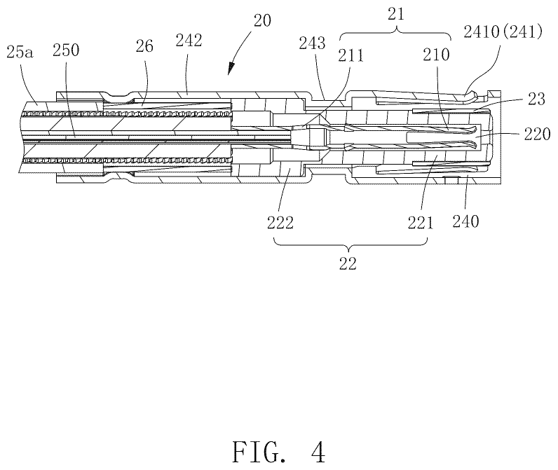

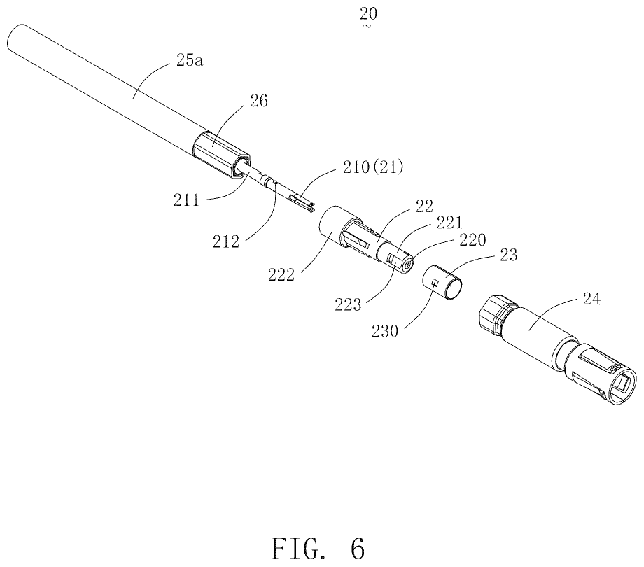

Referring to FIGS. 4 and 6, the inner conductor 21 has a contact portion 210 located on a front end and a connection portion 211 located on a rear end. The contact portion 210 is used to be engaged with the mating conductor component 40 of the mating connector 2, and the connection portion 211 is connected to an electrical component, such as a cable 25a. In other embodiments, the electrical component may be a circuit board or other components.

In the embodiment, the inner conductor 21 is a hollow tube, and its contact portion 210 is shaped like a claw, which has an elastic clamping function. For example, when the RF connector 1 is engaged with the mating connector 2, an central pin 41 of the mating conductor component 40 is inserted into the contact portion 210 of the inner conductor 21, and the contact portion 210 elastically clamps the central pin 41, thereby forming a stable electrical contact. The connection portion 211 of the inner conductor 21 is connected to a central wire 250 of the cable 25a, and they are fixed by crimping through a conductive sleeve 26. Further, the conductive sleeve 26 is pressed onto a shielding layer of the cable 25a.

Referring to FIGS. 4 and 6, the insulation support member 22 has a central cavity 220 for enclosing or accommodating the inner conductor 21. The insulation support member 22 includes a front support section 221 and a rear support section 222. The central cavity 220 passes through the front support section 221 and the rear support section 222. The contact portion 210 of the inner conductor 21 extends into the front support section 221, and the connection portion 211 of the inner conductor 21 extends into the rear support section 222. Moreover, the inner conductor 21 is provided with protrusions 212, which can be pressed against an inner wall of the central cavity 220 to fix the inner conductor 21 inside the central cavity 220.

Referring to FIGS. 4, 5 and 6, the inner shielding ring 23 is disposed on the outer peripheral surface of the insulation support member 22 and located on the front support section 221. Specifically, the inner shielding ring 23 is embedded in the front support section 221 and exposed on the outer peripheral surface of the insulation support member 22. Compared to existing designs, the front support section 221 of the insulation support member 22 can be thinned in this application. With this design, the impedance of the RF connector 1 of the present application can be effectively controlled. The specific details will be described later. In the embodiment, the inner shielding ring 23 is provided with a locking portion 230, and the insulation support member 22 is provided with an engaging portion 223 on the outer peripheral surface. The locking portion 230 can be engaged with the engaging portion 223, so that the inner shielding ring 23 is fixed on the outer peripheral surface of the front support section 221 of the insulation support member 22.

In the embodiment, the locking portion 230 of the inner shielding ring 23 may be a sheet that is made by a stamping process. The sheet is bent toward an inner side of the inner shielding ring 23. The engaging portion 223 of the insulation support member 22 is a groove. The sheet can be held in the groove to restrict the movement of the inner shielding ring 23.

In addition, it should be noted that the inner shielding ring 23 can be installed on the front support section 221 by an installation method, or the inner shielding ring 23 can also be molded with the front support section 221 by an injection molding process (also known as an integral molding process).

In the embodiment, the inner shielding ring 23 is an independent member.

In other embodiments, the inner shielding ring 23 may be not an independent member, but may be a metal layer or a metal surface formed on the outer peripheral surface of the insulation support member 22 by electroplating or other methods.

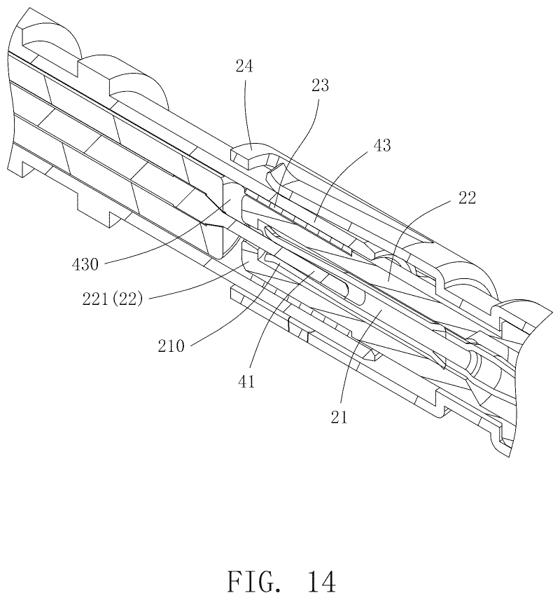

Please refer to FIG. 4, the outer conductor 24 surrounds the insulation support member 22, and defines a circular insertion space 240 between the outer conductor 24 and the insulation support member 22. When the RF connector 1 is engaged with the mating connector 2, the outer conductor 24 is engaged with an outer shielding shell 43 of the mating conductor component 40 of the mating connector 2 to form a shielding connection, as shown in FIG. 14. But at the same time, the outer shielding shell 43 is also connected to the inner shielding ring 23 to form a shielding connection, thereby reducing a shielding distance between the outer shielding shell 43 and the inner conductor 21. Moreover, by adjusting the shielding distance and/or the thickness of the front support section 221 of the insulation support member 22, the RF connector 1 of the present application can obtain a desired impedance value (such as 50 ohms, 70 ohms, or other values). That is to say, when designing the RF connector 1 of the present application, by disposing an inner shielding ring 23 on the front support section 221 of the insulation support member 22, the thickness of the front support section 221 can be controlled, thereby controlling the impedance of the RF connector 1 of the present application.

In addition, a complete shielding body is formed by connecting the outer conductor 24, the inner shielding ring 23 and the outer shielding shell 43, as shown in FIG. 14, to ensure high-quality signal transmission.

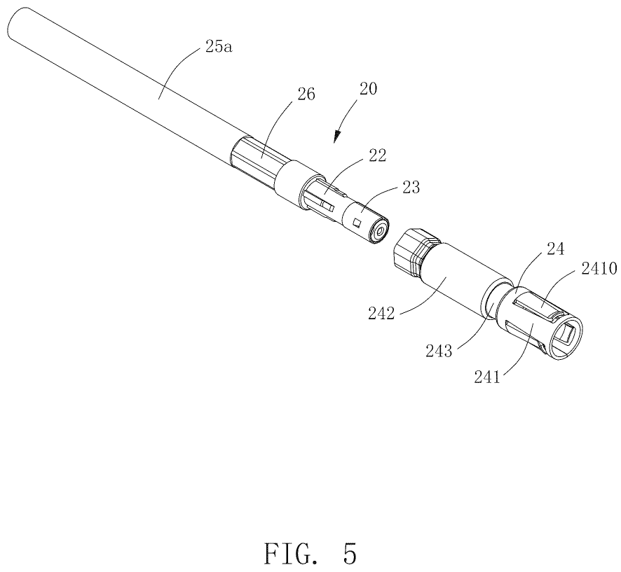

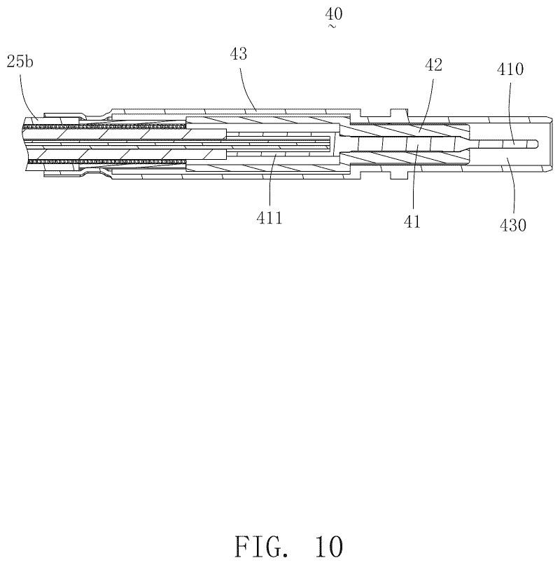

Specifically, in the embodiment, the outer conductor 24 has a front conductive portion 241 and a rear conductive portion 242. The front conductive portion 241 surrounds the front support section 221 of the insulation support member 22 and the inner shielding ring 23. The annular insertion space 240 is defined between the front conductive portion 241 of the outer conductor 24 and the inner shielding ring 23, and is used for inserting the outer shielding shell 43 of the mating conductor component 40 into it to form the shielding connection (see FIGS. 10 and 14). In the embodiment, as shown in FIGS. 4 and 5, the front conductive portion 241 has at least one elastic arm 2410. At least a part of the elastic arm 2410 protrudes toward the insertion space 240. In the embodiment, the front conductive portion 241 is shaped like a claw and has multiple elastic arms 2410 for commonly clamping the outer shielding shell 43.

In the embodiment, the outer conductor 24 further has a middle conductive portion 243. An inner diameter of the middle conductive portion 243 is smaller than an inner diameter of the front conductive portion 241 and also smaller than an inner diameter of the rear conductive portion 242. The middle conductive portion 243 surrounds and is pressed onto the insulation support member 22, especially between the front support section 221 and the rear support section 222 of the insulation support member 22 for restricting the movement of the outer conductor 24. The rear conductive portion 242 of the outer conductor 24 surrounds and is pressed onto the conductive sleeve 26, for further fixing the cable 25a and enhancing the shielding effect.

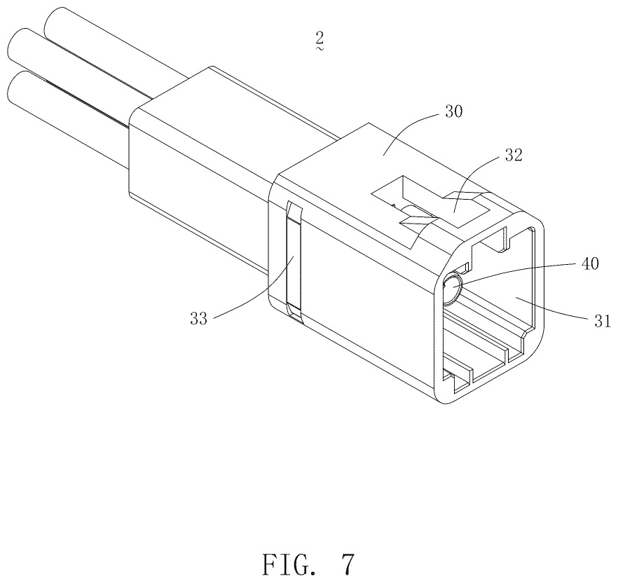

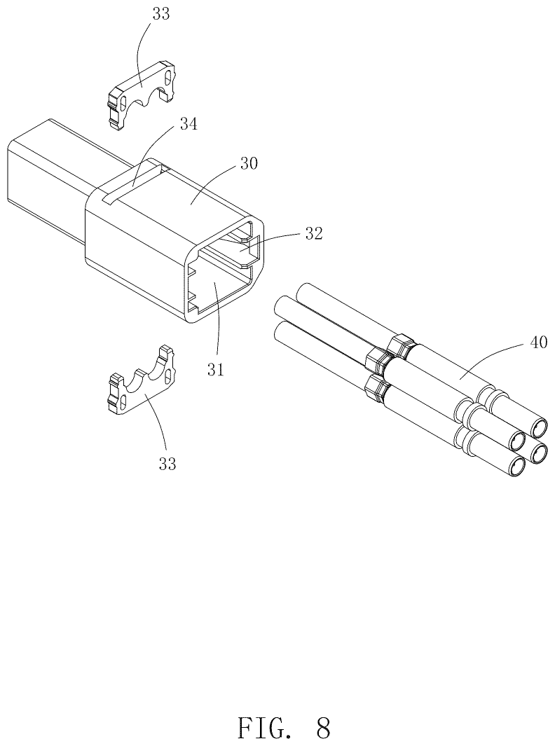

Please refer to FIGS. 7 and 8, the mating connector 2 serves as a male connector to be engaged with the RF connector 1 of the present application. The mating connector 2 includes a mating base 30 and at least one mating conductor component 40. The mating base 30 forms a cavity 31. The mating conductor component 40 is fixed in the the mating base 30 and extends into the cavity 31.

Referring to FIG. 7, the mating base 30 includes a retaining structure 32 disposed on a top of the mating base 30. Referring to FIG. 12, when the mating connector 2 is engaged with the RF connector 1 of the present application, the retaining structure 32 of the mating base 30 is mated with the latch structure 12 of the insulation base 20 for retaining the mating connector 2 and the RF connector 1 to be an engagement state. Referring to FIG. 8, the mating base 30 further includes a pair of insertion members 33 to be inserted into slots 34 of the mating base 30 for restricting the movement of the mating conductor component 40.

In the embodiment, the mating connector 2 includes four mating conductor components 40 corresponding to four central conductor components 20.

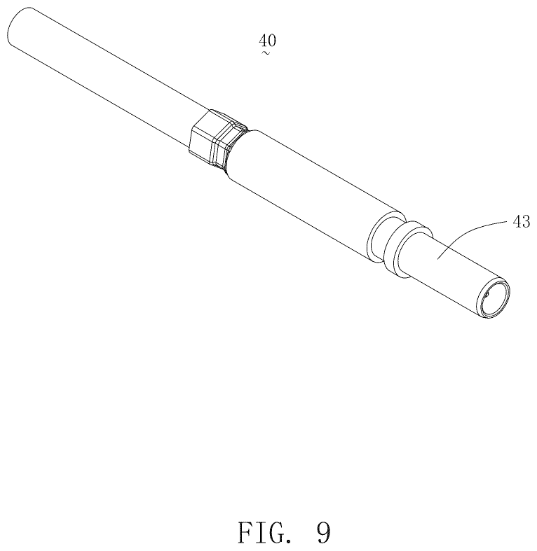

Please refer to FIGS. 9, 10 and 11, the mating conductor component 40 of the mating connector 2 includes a central pin 41, an insulation housing 42 for fixing the central pin 41, and an outer shielding shell 43 surrounding the insulation housing 42.

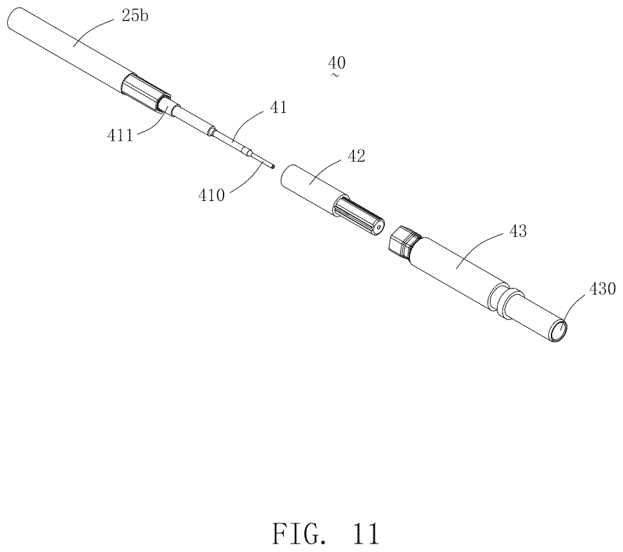

Referring to FIGS. 10 and 11, the central pin 41 has an insertion end 410 on a front end and a retaining end 411 on a rear end. The insertion end 410 extends out of a front end of the insulation housing 42 for being engaged with the inner conductor 21 of the RF connector 1. Specifically, the insertion end 410 can be inserted into the central cavity 220 of the insulation support member 22, enter into the tubular inner conductor 21 (see in FIG. 14), and electrically contact with the contact portion 210. The retaining end 411 is connected to an electrical component, such as a cable 25b.

Referring to FIG. 10, the insulation housing 42 is used to accommodate and fix the central pin 41.

Referring to FIG. 10, the outer shielding shell 43 is set on the insulation housing 42 and forms a mating space 430 located on a front of the insulation housing 42. The insertion end 410 of the central pin 41 extends out of the insulation housing 42 and is exposed in the mating space 430. That is to say, the mating space 430 surrounds the insertion end 410. The mating space 430 is used to accommodate the front support section 221 of the insulation support member 22 and the inner shielding ring 23 when being mated with the RF connector 1 of the present invention.

Please refer to FIGS. 12 to 14, a connector assembly 3 of the present application includes the RF connector 1 and the mating connector 2. As shown in FIG. 12, the insulation base 10 of the RF connector 1 enters into the cavity 31 of the mating base 30 of the mating connector 2, and the latch structure 12 of the insulation base 10 is mated with the retaining structure 32 of the mating base 30, so that the connector assembly 3 is locked in an engagement state.

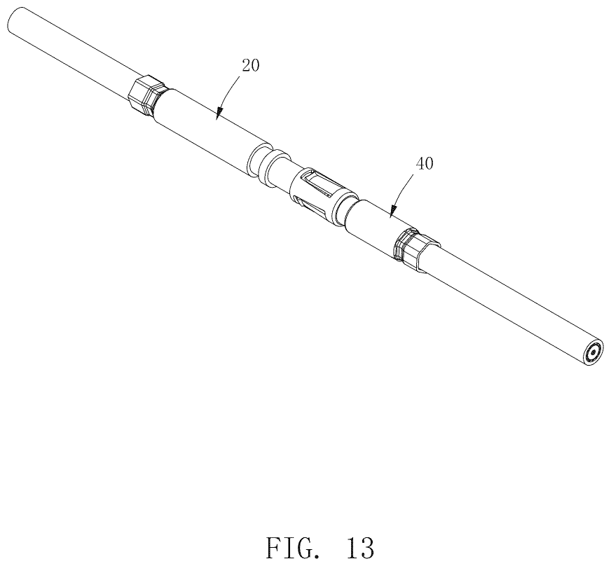

As shown in FIGS. 13 and 14, the central conductor component 20 and the mating conductor component 40 are in a mating state.

Specifically, as shown in FIG. 14, the central pin 41 is inserted into the central cavity 220 (reference number seen in FIG. 4) of the insulation support member 22, enters into the inner conductor 21, and forms an electrical contact with the contact portion 210 of the inner conductor 21 for signal transmission. The outer shielding shell 43 is inserted into the circular insertion space 240 (reference number seen in FIG. 4) between the outer conductor 24 and the inner shielding ring 23. Correspondingly, the front support section 221 of the insulation support member 22 and the inner shielding ring 23 enter into the mating space 430 of the outer shielding shell 43. At this moment, the outer conductor 24 contacts with the outer shielding shell 43, and the outer shielding shell 43 contacts with the inner shielding ring 23, thereby forming a complete shielding path that ensures better communication quality during high-frequency signal transmission. Particularly, the elastic arm 2410 of the outer conductor 24 can be pressed onto the outer shielding shell 43, thereby ensuring a stable contact of the both. The RF connector of the present application is particularly suitable for transmitting high-frequency signals, and can achieve a transmission frequency of 20 GHz.

As described above, the RF connector 1 of the present application is provided with the inner shielding ring 23 on the insulation support member 22 for controlling the impedance between the inner conductor 21 and the outer shielding shell 43 and solving the problem of impedance discontinuity caused by significantly high impedance in existing structures, which further leads to attenuation and increased reflection of signals when transmitting higher frequency signals. The RF connector 1 and the connector assembly 3 of the present application are particularly suitable for transmitting high-frequency signals, and can achieve a transmission frequency of 20 GHz.

It should be understood that, the application of the present application is not limited to the above examples listed. Ordinary technical personnel in this field can improve or change the applications according to the above descriptions, all of these improvements and transforms should belong to the scope of protection in the appended claims of the present application.

What is claimed is:

1. An RF connector, comprising an insulation base and at least one central conductor component disposed in the insulation base;
the central conductor component including an inner conductor, an insulation support member, an inner shielding ring and an outer conductor;
the inner conductor having a contact portion and a connection portion, the contact portion being used to be engaged with a mating conductor component of a mating connector;
the insulation support member having a central cavity for accommodating and supporting the inner conductor, the insulation support member including a front support section and a rear support section, the contact portion of the inner conductor extending into the front support section, and the connection portion of the inner conductor extending into the rear support section;
the inner shielding ring being disposed on an outer peripheral surface of the insulation support member and being located on the front support section;
the outer conductor surrounding the insulation support member and the inner shielding ring, and defining an annular insertion space between the outer conductor and the inner shielding ring for receiving an outer shielding shell of the mating conductor component inserted therein.

2. The RF connector according to claim 1, wherein the inner shielding ring is an independent member, which is embedded in the insulation support member by an installation method or an integral molding process and is exposed to the annular insertion space.

3. The RF connector according to claim 1, wherein the inner shielding ring is a metal layer or a metal surface formed on the outer peripheral surface of the insulation support member.

4. The RF connector according to claim 1, wherein the inner shielding ring is provided with a locking portion;
the insulation support member is provided with an engaging portion on the outer peripheral surface;
the locking portion is engaged with the engaging portion for fixing the inner shielding ring on the outer peripheral surface of the insulation support member; and
the locking portion of the inner shielding ring is a sheet that is bent toward an inner side of the inner shielding ring, the engaging portion of the insulation support member is a groove, and the sheet is held in the groove.

5. The RF connector according to claim 1, wherein the inner conductor is a hollow tube, and the contact portion of the inner conductor is shaped like a claw;
the connection portion of the inner conductor is connected to a central wire of a cable, and is fixed through a conductive sleeve; the conductive sleeve is pressed onto a shielding layer of the cable; and
the inner conductor is provided with protrusions that can be pressed against an inner wall of the central cavity.

6. The RF connector according to claim 5, wherein the outer conductor has a front conductive portion and a rear conductive portion;
the front conductive portion surrounds the front support section and the inner shielding ring, and the annular insertion space is defined between the front conductive portion and the inner shielding ring; and
the rear conductive portion surrounds and is pressed onto the conductive sleeve.

7. The RF connector according to claim 6, wherein the outer conductor further has a middle conductive portion;
an inner diameter of the middle conductive portion is smaller than an inner diameter of the front conductive portion and also smaller than an inner diameter of the rear conductive portion; and
the middle conductive portion surrounds and is fixed on the insulation support member.

8. The RF connector according to claim 6, wherein the front conductive portion is shaped like a claw, and has at least one elastic arm; and at least a part of the elastic arm protrudes toward the annular insertion space.

9. A connector assembly, comprising an RF connector and a mating connector;
the RF connector including an insulation base and at least one central conductor component disposed in the insulation base; the central conductor component including an inner conductor, an insulation support member, an inner shielding ring and an outer conductor;
the inner conductor having a contact portion and a connection portion;
the insulation support member including a front support section and a rear support section, the contact portion of the inner conductor being located in the front support section, and the connection portion of the inner conductor being located in the rear support section;
the inner shielding ring being disposed on an outer peripheral surface of the insulation support member and being located on the front support section; and
the outer conductor surrounding the insulation support member, and defining a circular insertion space between the outer conductor and the inner shielding ring; and
the mating connector including a mating base and at least one mating conductor component disposed in the mating base; the mating conductor component including a central pin, an insulation housing for fixing the central pin, and an outer shielding shell surrounding the insulation housing;
the central pin having an insertion end and a retaining end; the insertion end extending out of the insulation housing; and
the outer shielding shell forming a mating space, and the insertion end of the central pin being located in the mating space;
wherein, when the RF connector and the mating connector are engaged, the central pin contacts with the contact portion of the inner conductor for transmitting signals, the outer shielding shell is inserted into the circular insertion space, and the front support section and the inner shielding ring enter into the mating space of the out shielding shell; wherein, the outer conductor contacts with the outer shielding shell, and the outer shielding shell contacts with the inner shielding ring.

10. The connector assembly according to claim 9, wherein the insulation base includes at least one passage for retaining the central conductor component;
the insulation base includes a latch structure disposed on a top of the insulation base;
the mating base forms a cavity, and the mating conductor component is fixed in the mating base and extends into the cavity; and
the mating base includes a retaining structure disposed on a top of the mating base;
when the mating connector is engaged with the RF connector, the insulation base enters into the cavity of the mating base, and the retaining structure is mated with the latch structure.
